(19) United States
(12) Patent Application Publication
(10) Pub. No.: US 2021/0404498 A1
(43) Pub. Date: Dec. 30, 2021

(54) METHOD AND SYSTEM FOR JOINING CYLINDRICAL ELEMENTS BY MEANS OF ADHESIVE

(71) Applicant: ZENIT POLIMEROS Y COMPOSITES, S.L., Barcelona (ES)

(72) Inventor: Juan Alarcon Lorente, Barcelona (ES)

(21) Appl. No.: 16/498,340

(22) PCT Filed: Mar. 23, 2018
(86) PCT No.: PCT/ES2018/070234

§ 371 Date: Oct. 23, 2019

(30) Foreign Application Priority Data
Mar. 29, 2017 (ES) P201700321

(51) Int. Cl. F16B 7/04

(52) U.S. Cl. CPC F16B 7/0413

(57) ABSTRACT

Connection system between at least a first and a second connection element by means of adhesive, said first connection element comprising a projecting cylindrical portion suitable for being inserted inside a cylindrical housing of said second connection element, said projecting cylindrical portion comprising a groove arranged on the outer surface thereof for placing an adhesive for connecting said projecting cylindrical portion inside said cylindrical housing, in which said first connection element comprises a through-hole connected linearly with said groove for inserting an adhesive by means of an adhesive injection tube, said groove extending along the outer surface of the projecting cylindrical portion without reaching the end of said projecting cylindrical portion.

The present invention relates to the sector of connections between cylindrical elements used in particular in connections between support elements (transoms and standards) for scaffolding systems.

Connection systems between cylindrical elements using any type of adhesive which allow a permanent connection between the respective external and internal surfaces of the respective male and female cylindrical elements are known in the prior art. To provide efficient and strong adhesion between said connection elements, an even distribution of the adhesive along and between the external and internal surfaces respectively of the male and female cylindrical connection elements must be achieved. This provides long-lasting and strong adhesion over time, preventing the appearance of gaps without adhesive between said surfaces of the respective elements, which might cause an external agents, such as damp, for example, to enter, which could weaken the connection between said elements.

The adhesion systems known in the prior art have not until now managed to provide strong and long-lasting adhesive connections between cylindrical elements.

The present invention discloses a connection method for a connection system between cylindrical elements by means of adhesive, which comprises:
at least a first and a second connection element;
said first connection element comprising at least one projecting cylindrical portion suitable for insertion in a tight-fitting manner inside at least one cylindrical housing of said second connection element;
said projecting cylindrical portion comprising a groove arranged on the external surface thereof for placing an adhesive for permanently connecting said projecting cylindrical portion inside said cylindrical housing;

in which said first connection element comprises a through-hole that can be accessed from the outside connected linearly with said groove for inserting an adhesive by means of an adhesive injection tube, said groove extending along the outer surface of the projecting cylindrical portion without reaching the end of said projecting cylindrical portion, said method comprising:
an initial step of inserting the projecting cylindrical portion of the first connection element inside a cylindrical housing of at least one second connection element;

which also comprises the following steps:
inserting the adhesive injection tube through the through-hole of the first connection element as far as the end of the groove arranged on the outer surface of the projecting cylindrical portion:
injecting adhesive in the groove through the injection tube;
rotating the projecting cylindrical portion;
withdrawing the injection tube while continuing to inject the adhesive in the groove and continuing to rotate the projecting cylindrical portion.

The term ‘rotating the projecting cylindrical portion’ may refer to a rotation of said portion relative to the second connection element, preferably resulting in the rotation being such that there is no rotation of the injection means.

Preferably, the steps of injecting adhesive in the groove, rotating the projecting cylindrical portion and withdrawing the injection tube are carried out at the same time.

Preferably, the steps of injecting adhesive in the groove and withdrawing the injection tube are carried out at the same time.

Preferably, the rotation of the projecting cylindrical portion is carried out at a speed of between 20 and 120 revolutions per minute.

Preferably, the withdrawal of the injection tube is carried out at a constant speed of 0.01 m/s.

Preferably, the step of rotating the projecting cylindrical portion is carried out by means of a handle portion rigidly connected to said projecting cylindrical portion.

The present invention also relates to a connection system between cylindrical elements by means of an adhesive that is particularly suitable for carrying out the method of the invention and which comprises:
at least a first and a second connection element;
said first connection element comprising at least one projecting cylindrical portion suitable for being inserted in a tight-fitting manner inside at least one cylindrical housing of said second connection element;
said projecting cylindrical portion comprising a groove arranged on the outer surface thereof for placing an adhesive for permanently connecting said projecting cylindrical portion inside said cylindrical housing.

Said first connection element comprises a through-hole that can be accessed from the outside and is connected linearly with said groove for inserting an adhesive by means of an adhesive injection tube, said groove extending along the outer surface of the projecting cylindrical portion without reaching the end of said projecting cylindrical portion and the centre of the through-hole being aligned with the groove. The fact that said groove does not extend to the end of said projecting cylindrical portion ensures that the adhesive is placed only on the cylindrical surface area of the projecting cylindrical portion thus ensuring the adhesive cannot flow outside said outer surface of said projecting cylindrical portion.

Preferably, the centre of the through-hole is aligned with the mid-line of the groove.

Preferably, the groove has a depth of between 2 mm to 3 mm and the distance between the end of the groove and the end of the projecting cylindrical portion is 5 mm.

Preferably, the groove extends parallel to the longitudinal axis of said projecting cylindrical portion of the first connection element.

Preferably, the through-hole has a circular profile, the centre of which is aligned with the mid-line of a reinforcement rib of the cylindrical through-portion on which the groove is arranged. The mechanical weakness of the area where the groove is positioned is thus minimised as much as possible.

Preferably, the through-hole has a circular profile, the centre of which is aligned with the mid-line of the groove.

Preferably, the adjoining edges of the groove have a rounded form measuring 1 mm, thus allowing the adhesive to flow outside the groove during the adhesion process which will be explained below.

Preferably, said first connection element comprises a handle portion arranged rigidly connected to said projecting cylindrical portion. Said handle portion allows the first connection element to be grasped more conveniently during the insertion thereof inside the housing of the second connection element and/or during the adhesion process which will be explained below.

For a better understanding of the invention, the accompanying drawings of an embodiment of the invention are given as an explanatory but non-limiting example.

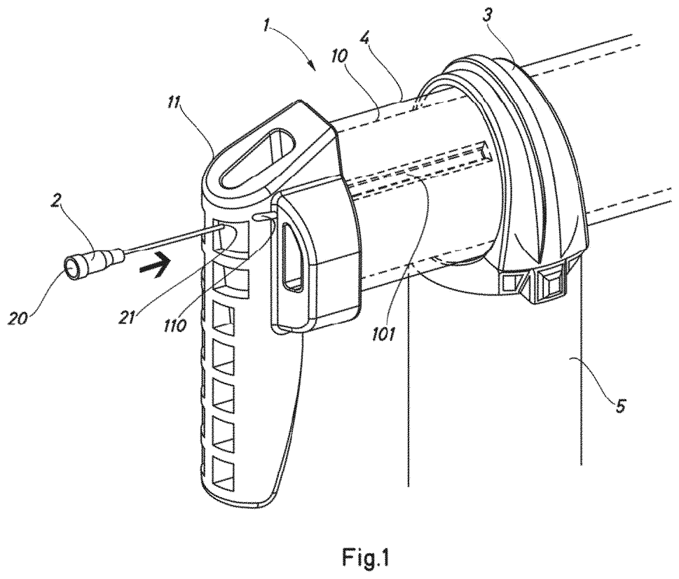

FIG. 1 is a perspective view of a connection system between cylindrical elements by means of adhesive according to the present invention.

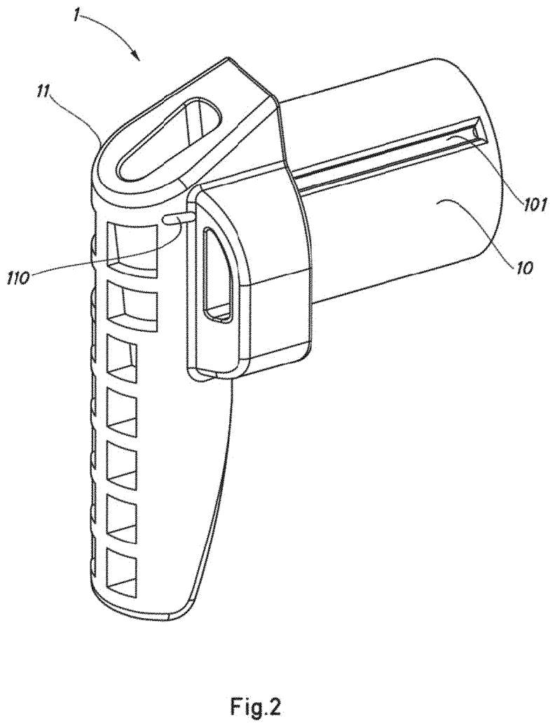

FIG. 2 is a perspective view of an embodiment of a first connection element of a system according to the present invention.

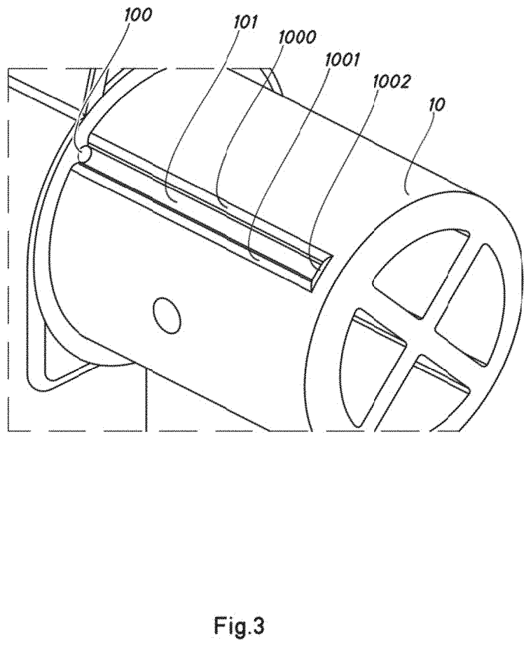

FIG. 3 is a view in detail of the projecting cylindrical portion of the first connection element of FIG. 2

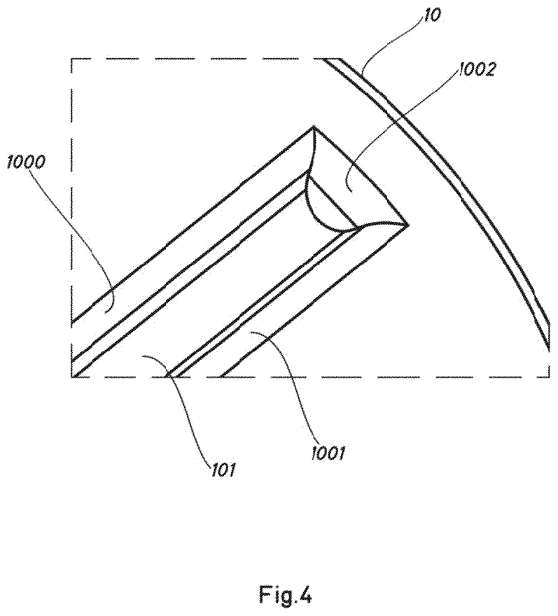

FIG. 4 is an enlarged view in detail of the projecting cylindrical portion of FIG. 3.

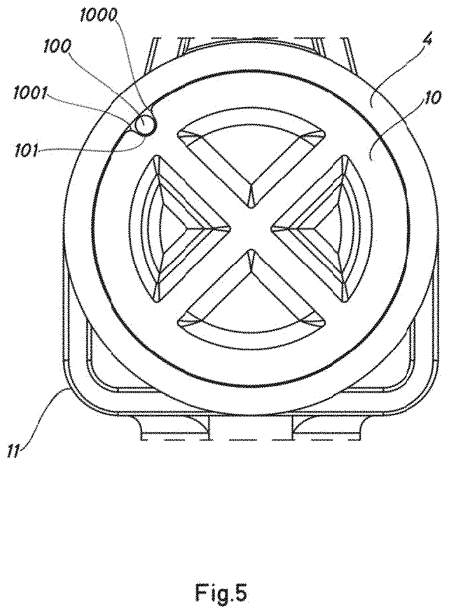

FIG. 5 is a rear view in detail of the first connection element of FIG. 2.

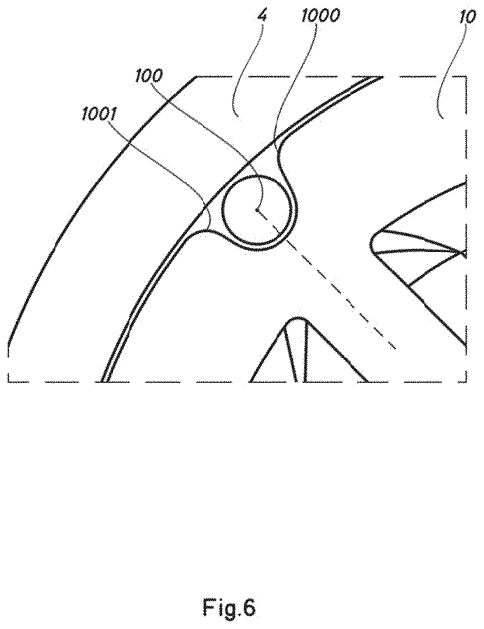

FIG. 6 is an enlarged view in detail of FIG. 5.

FIG. 1 shows a connection system between cylindrical elements by means of adhesive according to the present invention. Said system is made up of at least a first -1- and a second -4- connection element, and the second connecting element -4- may be part of another element, such as an interconnector -3- of different connection elements which connects, for example, horizontal connection elements with other, vertical connection elements -5-. Said first connection element -1- comprises at least one projecting cylindrical portion -10- suitable for being inserted in a tight-fitting manner inside at least one cylindrical housing of said second connection element -4-. FIG. 1 shows the system with the projecting cylindrical portion -10- of the first connection element -1- already inserted inside the cylindrical housing of said second connection element -4-.

FIG. 2 shows only the first connection element -1-, according to one embodiment, for the system according to the present invention. According to said embodiment, the projecting cylindrical portion -10- of the first connection element -1- comprises a groove -101- arranged on the outer surface thereof for placing an adhesive, as will be seen below, for permanently connecting said projecting cylindrical portion -10- inside said cylindrical housing of the second connection element -4-. Said first connection element -1- also comprises a through-hole with a proximal inlet -110- which can be accessed from the outside and a distal outlet -100- connected linearly with said groove -101- for inserting an adhesive by means of an adhesive injection tube -2- which comprises a proximal inlet -20- through which the adhesive (not shown) is inserted and a distal outlet -21- from which the adhesive emerges. Optionally, said first connection element -1- may comprise a handle portion -11- arranged rigidly connected to said projecting cylindrical portion -10- which allows the first connection element -1- to be grasped more conveniently during the insertion thereof inside the housing of the second connection element -4- and/or during the adhesion process which will be explained below.

As shown in FIG. 1 to 4, the groove -101- extends along the outer surface of the projecting cylindrical portion -10- without reaching the end thereof. Preferably, the groove has a depth of between 2 mm and 3 mm and the distance between the end of the groove and the end of the projecting cylindrical portion is 5 mm. Also preferably, the groove extends parallel to the longitudinal axis of said projecting cylindrical portion -10- of the first connection element -1-.

As can be seen in FIGS. 5 and 6, the through-hole (-100-, -110-) preferably has a circular profile, the centre of which is aligned with the mid-line of the groove and/or with the mid-line of a reinforcement rib of the cylindrical through portion -10- on which the groove -101- is arranged, thus minimising as much as possible the mechanical weakness of the area where the groove -101- is arranged.

In addition, as shown in FIGS. 3 and 4, the groove -101- comprises adjoining edges (lateral edges -1000- and -1001-: and end edge -1002-) which preferably have a rounded form measuring 1 mm, thus allowing and facilitating the flow of the adhesive (not shown) outside the groove -101- during the adhesion process which will be explained below.

Next, a connection method (not shown) by means of adhesive in a system according to the present invention will be explained.

Initially, the method includes an initial step of inserting the projecting cylindrical portion -10- of the first connection element -1- inside a cylindrical housing of the second connection element -4-.

Next, the method comprises the step of inserting the adhesive injection tube -2- through the through-hole (-100-, -110-) as far as the end of the groove -101- arranged on the outer surface of the projecting cylindrical portion -10-, so that the distal outlet -21- of said tube -2- is arranged at the end of said groove -101-. Next, the adhesive is injected into the groove -101- through the proximal inlet -20- of the injection tube -2- and the rotation of the projecting cylindrical portion -10- inside the housing of the second connection element -4- begins, allowing an even distribution of the adhesive axially. As an example, the rotation of the projecting cylindrical portion -10- may be carried out at a speed of between 20 and 120 revolutions per minute. Next, the injection tube -2- is progressively withdrawn while continuing to inject the adhesive into the groove -101- and continuing to rotate the projecting cylindrical portion -10-, thus achieving a uniform and even distribution of the adhesive both on the axial and longitudinal axes of the projecting cylindrical portion -10- inside the housing of the second connection element -4-, obtaining a stronger and longer lasting connection with no spaces with no adhesive between the projecting cylindrical portion -10- and the inner surface of the housing of the second connection element -4-. As an example, the injection tube may be withdrawn at a constant speed of 0.01 m/s.

Preferably, the steps of injecting adhesive in the groove -101-, axially rotating the projecting cylindrical portion -10- and withdrawing the injection tube -2- are all carried out at the same time. However, different combinations of the above-mentioned steps may be carried out at different points in time.

Optionally, the step of rotating the projecting cylindrical portion -10- may be carried out by means of a handle portion -11- which is optionally arranged rigidly connected to said projecting cylindrical portion -10-.

Although the invention has been presented and described with reference to an embodiment thereof with some elements which are optional and therefore not essential for the invention, it will be understood that said elements do not limit the invention, and many structural or other details, which may be evident to persons skilled in the art after interpreting the subject matter which is disclosed in the present description, claims and drawings, may vary. Thus, all variants and equivalents will be included within the scope of the present invention if said variants and equivalents may be considered to fall within the most extensive scope of the following claims.

1. A connection system between cylindrical elements by means of an adhesive that is particularly suitable for carrying out the method of the invention and which comprises:
at least a first and a second connection element;
said first connection element comprising at least one projecting cylindrical portion suitable for being inserted in a tight-fitting manner inside at least one cylindrical housing of said second connection element;
said projecting cylindrical portion comprising a groove arranged on the outer surface thereof for placing an adhesive for permanently connecting said projecting cylindrical portion inside said cylindrical housing,
wherein said first connection element comprises a through-hole that can be accessed from the outside connected linearly with said groove for inserting an adhesive by means of an adhesive injection tube, said groove extending along the outer surface of the projecting cylindrical portion without reaching the end of said projecting cylindrical portion, characterised in that the centre of the through-hole is aligned with the groove.

2. The connection system according to claim 1, wherein the groove extends parallel to the longitudinal axis of said projecting cylindrical portion of the first connection element.

3. The connection system according to either claim 1, wherein the through-hole has a circular profile, the centre of which is aligned with the mid-line of a reinforcement rib of the cylindrical through-portion.

4. The connection system according to claim 1, wherein the through-hole has a circular profile, the centre of which is aligned with the mid-line of the groove.

5. The connection system according to claim 1, wherein the adjoining edges of the groove have a rounded form measuring 1 mm.

6. The connection system according to claim 1, characterised in that the groove has a depth of between 2 mm to 3 mm.

7. The connection system according to claim 1, characterised in that the distance between the end of the groove and the end of the projecting cylindrical portion is 5 mm.

8. The connection system according to claim 1, wherein said first connection element comprises a handle portion arranged rigidly connected to said projecting cylindrical portion.

9. A connection method for a connection system between cylindrical elements by means of adhesive, which comprises:
at least a first and a second connection element;
said first connection element comprising at least one projecting cylindrical portion suitable for insertion in a tight-fitting manner inside at least one cylindrical housing of said second connection element;
said projecting cylindrical portion comprising a groove arranged on the external surface thereof for placing an adhesive for permanently connecting said projecting cylindrical portion inside said cylindrical housing;
wherein said first connection element comprises a through-hole that can be accessed from the outside connected linearly with said groove for inserting an adhesive by means of an adhesive injection tube, said groove extending along the outer surface of the projecting cylindrical portion without reaching the end of said projecting cylindrical portion,
said method comprising:
an initial step of inserting the projecting cylindrical portion of the first connection element inside a cylindrical housing of at least one second connection element;
which also comprises the following steps:
inserting the adhesive injection tube through the through-hole of the first connection element as far as the end of the groove arranged on the outer surface of the projecting cylindrical portion;
injecting adhesive in the groove through the injection tube;
rotating the projecting cylindrical portion;
withdrawing the injection tube while continuing to inject the adhesive in the groove and continuing to rotate the projecting cylindrical portion.

10. The connection method according to claim 9, wherein the steps of injecting adhesive in the groove, rotating the projecting cylindrical portion and withdrawing the injection tube are carried out at the same time.

11. The connection method according to claim 9, wherein the steps of injecting adhesive in the groove and withdrawing the injection tube are carried out at the same time.

12. The connection method according to claim 9, wherein the rotation of the projecting cylindrical portion is carried out at a speed of between 20 and 120 revolutions per minute.

13. The connection method according to claim 9, wherein the withdrawal of the injection tube is carried out at a constant speed of 0.01 m/s.

14. The connection method according to claim 9, wherein the step of rotating the projecting cylindrical portion is carried out by means of a handle portion rigidly connected to said projecting cylindrical portion.
